(19) United States
(12) Patent Application Publication
(10) Pub. No.: US 2025/0215164 A1
(43) Pub. Date: Jul. 3, 2025

(54) METHOD FOR PURIFYING LIGNIN

(71) Applicant: Stora Enso OYJ, Helsinki (FI)

(72) Inventors: Vilhelm Olsson, Täby (SE); Ulrika Stockwell, Stockholm (SE); Maria Björk, Karlstad (SE)

(73) Assignee: Stora Enso OYJ, Helsinki (FI)

(21) Appl. No.: 18/853,525

(22) PCT Filed: Apr. 3, 2023
(86) PCT No.: PCT/IB2023/053331

§ 371 Date: Oct. 2, 2024

(30) Foreign Application Priority Data
Apr. 4, 2022 (SE) 2250426-0

(51) Int. Cl. C08H 7/00

(52) U.S. Cl. CPC C08H 6/00

(57) ABSTRACT

The present invention relates to a method for purifying lignin comprising the steps of: providing lignin in solid form, immersing the lignin in an acidic aqueous solution so as to remove metals from the lignin to the acidic aqueous solution and separating purified lignin from the acidic aqueous solution. The present invention also relates to lignin having a total metal content below 200 ppm. The purified lignin disclosed in the present invention may be further processed into carbon enriched materials.

### FIELD OF THE INVENTION

The present invention relates to a method for purifying lignin, wherein metals are removed from lignin. In addition, the present invention relates to lignin having a total metal content below 200 ppm. The purified lignin can be further processed to end products such as carbon enriched materials.

### BACKGROUND

Lignin, an aromatic polymer, is a major constituent in e.g. wood, and is the most abundant carbon source on Earth second only to cellulose. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry.

Today, the most commercially relevant source of lignin is kraft lignin. This lignin is obtained from hardwood or softwood through the kraft process. The lignin can be separated from alkaline black liquor using for example membrane-or ultrafiltration. LignoBoost is one common separation process and is described in for example WO2006031175 A1. In this process, lignin is precipitated from alkaline black liquor through reducing the pH level, usually by adding carbon dioxide, and then filtered off. The lignin filter cake is in the next step re-slurried under acidic conditions, commonly using sulfuric acid, and washed. The precipitated washed lignin can be used as it is or further dried.

Black liquor is readily available as a by-product from the kraft process and is thus a cost-efficient lignin source. However, as black liquor contains a certain amount of metals, mostly originating from wood and from cooking chemicals used during the pulping process, lignin precipitated from the black liquor will also contain a certain amount of metals. Generally, the lignin will comprise relatively high levels of sodium and potassium, as well as lower amounts of other metals such as aluminum, calcium, iron, magnesium and manganese. The lignin may also comprise trace amounts of other metals.

Some metals, such as sodium and potassium, can to a large extent be removed from precipitated lignin by acidic washing steps during the separation process. Other metals are however harder to remove from the precipitated lignin. In many potential applications, such as in biofuels and for conversion to carbon enriched materials, such as carbon fibers and carbon powders, it is important that the lignin used has a high purity, in particular with regards to the amount of metals, that may otherwise interfere with the functionality of the material. This is of particular importance when lignin is further intended for conversion to carbon enriched materials that in turn is to be used in energy storage applications. Specifically, transition metals such as iron and manganese may, if present in energy storage applications involving carbon enriched materials obtained from lignin, have a negative impact on the long-term stability of the energy storage device. It is believed that this is caused by precipitation of transition metals during charging and discharging, and also by decomposition of the electrolyte by reactions in turn catalyzed by transition metals.

Lignin may also be obtained through different fractionation methods such as an organosolv process or hydrolysis lignin. The organosolv process is however of less commercial interest for producing lignin compared to the kraft process.

Various attempts of removing metals from lignin have been made. Common for these methods is that they are rather complex involving many additional processing steps; and/or that they are not sufficiently efficient in their metal removal efficiency leading to insufficient purity levels and/or long washing times.

KR101451299 B1 discloses a method where lignin is repeatedly dissolved and precipitated in order to obtain a lignin with low ash content. However, many additional process steps are required.

WO2020013752 A1 discloses a method where lignin is dissolved in an acidic aqueous solvent. Through phase separation a two-phase system is obtained, where one phase is a lignin rich phase, and the other phase is poor in lignin and comprises metal cations extracted from lignin. Many additional process steps are however required.

Thus, there is a need for an improved method for purifying lignin where the obtained purified lignin has a metal content that is sufficiently low so that the purified lignin can be used also in applications where a material of high purity is required. In addition, the method should be cost-efficient and compatible with large-scale manufacturing.

### SUMMARY OF THE INVENTION

It is an object of the present invention to provide an improved method for purifying lignin, which method eliminates or alleviates at least some of the disadvantages of the prior art methods.

It is a further object of the present invention to provide a method for purifying lignin wherein the obtained lignin has a reduced total metal content.

It is a further object of the present invention to provide a method for purifying lignin, which method is compatible with large-scale manufacturing.

The above-mentioned objects, as well as other objects as will be realized by the person skilled in the art in light of the present invention, are achieved by the various aspects of the present invention.

According to a first aspect, the present invention is directed to a method for purifying lignin, wherein the method comprises the following steps:
a) providing lignin in solid form;
b) providing an acidic aqueous solution having a pH below 6;
c) immersing the lignin in the acidic aqueous solution for at least 15 minutes, wherein the temperature of the acidic aqueous solution during the immersion is in the range of from 40° C. to 100° C., to remove metals from lignin to the acidic aqueous solution so as to obtain said purified lignin;
d) separating the obtained purified lignin from the acidic aqueous solution; and
e) optionally washing the separated purified lignin
   wherein the lignin remains in solid form during all steps of the method.

The inventive method according to the first aspect is based on the surprising realization that metals can be removed from lignin in solid form by immersing the lignin in an acidic aqueous solution for at least 15 minutes at a temperature in the range of from 40° C. to 100° C. This enables a method for purifying lignin that is fast and comprises few additional method steps, and that can be performed using the existing processing equipment that is employed during production of lignin from black liquor. The method is thus compatible with large-scale manufacturing.

According to a second aspect, the present invention is directed to lignin having a total metal content below or equal to 200 ppm.

A lignin material with a low content of metals is of interest in a number of different applications, such as in biofuels and for conversion to carbon enriched materials such as carbon fibers and carbon powders, in particular for use in energy storage applications.

### DETAILED DESCRIPTION

Step a) of the method according to the first aspect involves providing lignin in solid form. It is intended throughout the present description that the expression “lignin” embraces any kind of lignin, e.g. lignin originated from hardwood, softwood or annular plants. Also, lignin can be chemically modified. Preferably, the lignin has been purified or isolated before being used in the process according to the present invention. The lignin may be isolated from black liquor and optionally be further purified before being used in the process according to the present invention. The purification is typically such that the purity of the lignin material is at least 90%, preferably at least 95%, more preferably at least 98%, based on the dry weight of the lignin material, Thus, the lignin material used according to the process of the present invention preferably contains less than 10%, preferably less than 5%, more preferably less than 2% impurities, such as cellulose and inorganic compounds, based on the dry weight of the lignin material.

The lignin may be obtained through different fractionation methods such as an organosolv process or a kraft process. Preferably, the lignin provided in step a) of the method according to the first aspect is kraft lignin, i.e. lignin obtained through the kraft process. Preferably, the kraft lignin is obtained from hardwood or softwood, most preferably from softwood.

The lignin may be obtained by using the process disclosed in WO2006031175 A1 commonly referred to as the LignoBoost process.

Typically, this process involves the steps of precipitation of lignin from alkaline black liquor by acidification; separation of the precipitated lignin; and re-slurrying the lignin under acidic conditions at least once. The obtained lignin may be dried and pulverized and thus provided as solid particles. The lignin obtained by this method typically has a total metal content in the range of from 500 ppm to 5000 ppm, originating mainly from the wood source and cooking chemicals added during the pulping process. The pH of the obtained lignin is typically in the range of from 3 to 4. The sulfur content of the obtained lignin is typically around 1-3 wt %. This lignin is the preferable starting material of the method of the present invention.

The term “total metal content”, as used herein, refers to the total amount of metals present in the lignin. Typically, metals present in lignin are sodium, potassium, magnesium, calcium, aluminum, iron, and manganese. Trace amounts of other metals may also be present. The metal content may be determined by inorganic elemental analysis. The total metal content is determined by summarizing the amounts of all individual metals. In one embodiment, the lignin provided in step a) of the inventive method according to the first aspect has a total metal content of at least 500 ppm, preferably at least 600 ppm and more preferably at least 700 ppm. In another embodiment, the lignin provided in step a) of the method according to the first aspect has a total metal content in the range of from 500 ppm to 5000 ppm, preferably in the range from 600 ppm to 3000 ppm, and more preferably in the range from 700 ppm to 1500 ppm.

In one embodiment, the lignin provided in step a) of the method according to the first aspect may have an aluminum content of at least 18 ppm, or at least 19 ppm; a calcium content of at least 18 ppm, or at least 19 ppm; an iron content of at least 16 ppm, or at least 17 ppm; a potassium content of at least 30 ppm, or at least 50 ppm; a magnesium content of at least 45 ppm, or at least 48 ppm; a manganese content of at least 11 ppm, or at least 12 ppm; and a sodium content of at least 400 ppm, or at least 650 ppm.

In an alternative embodiment, the lignin provided in step a) of the method according to the first aspect has an aluminum content in the range of from 18 to 25 ppm, preferably from 19 to 23 ppm; a calcium content in the range of from 18 to 40 ppm, preferably from 19 to 25 ppm; an iron content in the range of from 16 to 30 ppm, preferably from 17 to 22 ppm; a potassium content in the range of from 30 to 90 ppm, preferably from 50 to 70 ppm; a magnesium content in the range of from 45 to 55 ppm, preferably from 48 to 53 ppm; a manganese content in the range of from 11 to 30 ppm, preferably from 12 to 16 ppm; and a sodium content in the range of from 400 ppm to 2000 ppm, preferably from 650 to 1000 ppm.

The lignin provided in step a) of the method according to the first aspect may also have a silicon content of at least 90 ppm, or at least 100 ppm. Alternatively, the silicon content may be in the range of from 90 to 140 ppm, preferably from 100 to 130 ppm.

The lignin provided in step a) of the method according to the first aspect is in solid form, i.e. it is not in a dissolved state. In one embodiment, the lignin is provided in the form of a dry powder. Alternatively, the lignin may be moist or provided in a slurry or suspension. The lignin may also be provided as a crushed lignin cake obtained from a lignin separation process. The lignin is not dissolved during any of the steps in the method according to the first aspect but remains in solid form.

Alternatively, the lignin may be dissolved to a small extent, such that only small fragments of the solid lignin is dissolved, during the steps of the method according to the present invention. Thus, the lignin will remain largely in solid state. Any dissolved lignin will be removed during the separation step and discarded from the process.

Preferably, the lignin provided in step a) of the method according to the first aspect is in particulate form, such as in the form of a powder. The particle size distribution of the lignin particles is preferably such that at least 80 wt % of the particles have a diameter less than 0.2 mm. In the context of the present invention, the diameter of a particle is the equivalent spherical diameter of the particle, if the particle is not spherical. The equivalent spherical diameter is the diameter of a sphere of equivalent volume.

Step b) of the method according to the first aspect involves providing an acidic aqueous solution having a pH below 6. The term “acidic aqueous solution” as used herein, refers to any type of aqueous solution having a pH below 7. The acidic aqueous solution in step b) of the method according to the first aspect may be provided by adding at least one acid to an aqueous solution. The pH of the acidic aqueous solution provided in step b) of the method according to the first aspect has a pH below 6, preferably below 5 and more preferably below 4. In an alternative embodiment, the pH of the acidic aqueous solution may be below 7. In yet an alternative embodiment, the pH of the acidic aqueous solution may be in the range of from 1 to 6, preferably from 1 to 5, and more preferably from 1 to 4.

Lignin may be added to the aqueous solution after the acid has been added. Alternatively, lignin may be added to the aqueous solution prior to adding the acid. The aqueous solution is heated either before or after addition of the acid and lignin. In one embodiment, the acid is added to a heated aqueous solution, to which lignin is subsequently added. In another embodiment, lignin is added to an acidic aqueous solution which is subsequently heated. In yet another embodiment, acid is added to an aqueous solution comprising lignin. In this embodiment, the aqueous solution is heated either before or after addition of acid. In a preferred embodiment, lignin is added to a heated aqueous solution, and acid is subsequently added to the aqueous solution comprising lignin.

The acidic aqueous solution comprises at least one acid such that the pH of the acidic aqueous solution is below 7, or below 6, or below 5 or below 4. In one preferred embodiment, the acidic aqueous solution comprises at least one organic acid. The organic acid may be a carboxylic acid and may be monoprotic, diprotic or triprotic. In a preferred embodiment, the organic acid has a pKa value for at least one acidic group of equal to or less than 4.75. The organic acid may be selected from at least one of acetic acid, citric acid, formic acid and oxalic acid. Preferably, the acidic aqueous solution comprises at least one organic acid selected from formic acid and oxalic acid. Using an organic acid has been found to further reduce the metal content in lignin during the immersion step. Organic acids such as formic acid and oxalic acid are cheap, easy to handle, have low toxicity and are usually less restricted to certain waste disposal regulations compared to acids containing sulfur, nitrogen and/or phosphorus.

In an alternative embodiment, the acidic aqueous solution comprises at least one inorganic acid such as sulfuric acid, hydrochloric acid or phosphoric acid.

The acidic aqueous solution may also comprise more than one acid, such as a combination of two or more organic acids or inorganic acids. The acidic aqueous solution may also comprise a combination of organic and inorganic acids. In one embodiment, the acidic aqueous solution comprises both formic acid and oxalic acid.

In one embodiment of the method according to the first aspect, the total amount of acid in the acidic aqueous solution is in the range of from 0.1 to 6 wt %, preferably from 0.5 to 5 wt %, based on the dry weight of lignin immersed in the acidic aqueous solution. The term “total amount of acid” as used herein, refers to the total amount of concentrated acid added to the acidic aqueous solution. Increasing the amount of acid may increase the removal of metals from lignin. From a process perspective it is however beneficial to avoid using large amounts of acids both for cost reasons and as waste handling is facilitated. Also, side reactions that may degrade lignin can be triggered by increasing the amount of acid in the acidic aqueous solution.

The acidic aqueous solution may further comprise one or more additives. The additive may be a dispersant, such as glycerol or a fatty acid. The additive may also be an oxidant such as hydrogen peroxide or EDTA. Other additives include ion exchangers such as ammonium salts such as ammonium acetate and ammonium sulfate. Additives in the acidic aqueous solution may enhance the effect of removing metals from lignin.

Step c) of the method according to the first aspect involves immersing the lignin particles in the acidic aqueous solution for at least 15 minutes, wherein the temperature of the acidic aqueous solution during the immersion is in the range of from 40° C. to 100° C., to remove metals from lignin to the acidic aqueous solution so as to obtain said purified lignin.

The term “immersion” as used herein, refers to a process of contacting lignin in solid form, such as in the form of lignin particles, with an acidic aqueous solution for a certain period of time. During the immersion step of the method according to the first aspect, the entire surface area of the lignin is in contact with the acidic aqueous solution, meaning that the lignin is fully submerged in the acidic aqueous solution.

The lignin is immersed in the acidic aqueous solution at a temperature in the range of from 40° C. to 100° C., such as from 50° C. to 90° C., or from 60° C. to 80° C. In one embodiment, the lignin is immersed in the acidic aqueous solution at a temperature in the range of from 40° C. to 110° C., such as from 80° C. to 100° C. The acidic aqueous solution may be heated using any suitable means as known by a person skilled in the art. The temperature is kept in the defined range during the entire immersion step. By heating the acidic aqueous solution, the metal removal efficiency is increased. If a too high temperature is used, the lignin may however be damaged or degraded.

The immersion time in step c) of the method according to the first aspect is at least 15 minutes, preferably at least 30 minutes, or even more preferably at least 1 hour. In an alternative embodiment of the method according to the first aspect, the immersion time is in the range of from 15 minutes to 6 hours, preferably in the range of from 30 minutes to 5 hours, or even more preferably in the range of from 1 hour to 4 hours. By increasing the immersion time, the metal removal efficiency may be increased. However, in order to enable a cost-efficient method that can easily be scaled up, it is important to have a relatively short immersion time. Still, the immersion time must be long enough for sufficient removal of metals from lignin.

In a preferred embodiment of the method according to the first aspect, the acidic aqueous solution is stirred during the immersion step. Any suitable stirring means as known by a person skilled in the art may be used.

During the immersion step, metals are removed from lignin to the acidic aqueous solution so that purified lignin is obtained. The term “purified lignin” as used herein refers to a lignin material that comprise essentially only lignin, such as at least 99 wt % lignin based on the dry weight of the lignin material and less than 1 wt % of other components such as cellulose, and inorganic compounds, based on the dry weight of the lignin material. In particular, the purified lignin comprises a reduced amount of metals. In a preferred embodiment of the method according to the first aspect, the purified lignin obtained in step c) of the method has a total metal content of less than 200 ppm, preferably less than 150 ppm and more preferably less than 100 ppm.

As mentioned above, the lignin is not dissolved during the immersion step, which means that metals are removed from solid lignin and not from dissolved lignin. Thus, the purified lignin obtained in step c) of the method according to the first aspect is also in solid form, such as in the form of particles.

Low-metal lignin is obtained by the inventive method according to the first aspect. Preferably the lignin is in particulate form so that low-metal lignin particles are obtained.

Step d) of the method according to the first aspect involves separating the obtained purified lignin from the acidic aqueous solution. The purified lignin is in solid form during the separation. The term “separation” as used herein, refers to a process of separating the lignin from the acidic aqueous solution.

In a preferred embodiment of the method according to the first aspect, the separation in step d) is performed using filtration. Alternatively, the separation may be performed by centrifuging or sedimentation or any other suitable means known by a person skilled in the art. As the purified lignin is separated from the acidic aqueous solution, the pH of the acidic aqueous solution and the lignin during the separation step will be the same as the pH during the immersion step. Thus, the pH of the aqueous acidic solution is below 6, preferably below 5, or more preferably below 4, during the step of separating the purified lignin. In one embodiment, the pH of the aqueous acidic solution may be in the range of from 1 to 7, preferably from 2 to 6, more preferably from 2 to 5, and most preferably from 2 to 4.

In one embodiment of the method according to the first aspect, steps c-d and optionally e) are repeated at least one time. The separated lignin is in this embodiment immersed in an acidic aqueous solution a second time, before a second separation step. The pH of the acidic aqueous solution and the temperature and time during the immersion step are selected as discussed above. In the embodiment where the immersion and separation steps are repeated, parameters such as pH, temperature and time during the immersion may be the same in all the immersion steps or they may vary between different immersion steps. In one embodiment, the same parameters are used during two immersion steps. In one embodiment, the pH may be lower in a second immersion step than in a first immersion step.

In another embodiment, the immersion time may be shorter in a second immersion step than in a first immersion step. In yet another embodiment, the temperature may be higher in a first immersion step than in a second immersion step. The total immersion time is the sum of the immersion times for the individual steps. The separation is preferably performed by filtration after each immersion step. The metal content of the lignin may be further reduced by adding additional immersion steps and by optimizing parameters such as time, temperature and pH of each step.

Step e) of the method according to first aspect involves optionally washing the separated purified lignin. In one embodiment of the method according to the first aspect, the separated lignin is subjected to washing with an aqueous washing solution. The aqueous washing solution is preferably water. In one embodiment, the separated purified lignin is washed with water until the pH of the water used for washing becomes neutral.

In one embodiment of the method according to the first aspect, the method comprises an additional step of drying the separated, and optionally washed, purified lignin. The purified lignin may be dried after the separation step or after the optional washing step. The drying of the purified lignin may be carried out by methods and equipment known in the art. The temperature during the drying is preferably in the range of from 60° C. to 160° C., more preferably in the range of from 100° C. to 120° C. The drying may be performed under ambient pressure, reduced pressure or vacuum.

The purified lignin obtained by the method according to the first aspect may have a total metal content of less than 200 ppm, preferably less than 150 ppm and more preferably less than 100 ppm.

The purified lignin obtained by the method according to the first aspect may have an aluminum content of less than 17 ppm, or less than 13 ppm; a calcium content of less than 16 ppm, or less than 10 ppm; a potassium content of less than 10 ppm, or less than 5 ppm; a magnesium content of less than 42 ppm, or less than 25 ppm; and a sodium content of less than 30 ppm, or less than 15 ppm.

The purified lignin obtained by the method according to the first aspect may have an iron content of less than 15 ppm, preferably less than 10 ppm.

The purified lignin obtained by the method according to the first aspect may have a manganese content of less than 10 ppm, preferably less than 6 ppm.

In an alternative embodiment, the purified lignin obtained by the method according to the first aspect may have a total metal content in the range of from 0 to 200 ppm, such as from 0.1 to 200 ppm, preferably in the range of from 0 to 150 ppm, such as from 0.1 to 150 ppm and more preferably in the range of from 0 to 100 ppm, such as from 0.1 to 100 ppm.

In an alternative embodiment, the purified lignin obtained by the method according to the first aspect may have an iron content in the range of from 0 to15 ppm, or from 0 to 10 ppm, or from 0.1 to 15 ppm, or from 0.1 to 10 ppm.

In an alternative embodiment, the purified lignin obtained by the method according to the first aspect may have a manganese content in the range of from 0 to 10 ppm, or from 0 to 6 ppm, or from 0.1 to 10 ppm, or from 0.1 to 6 ppm.

In an alternative embodiment, the purified lignin obtained by the method according to the first aspect may have an aluminum content in the range of from 0 to 17 ppm, or from 0 to 13 ppm; a calcium content in the range of from 0 to 16 ppm, or from 0 to 10 ppm; a potassium content in the range of from 0 to 10 ppm, or from 0 to 5 ppm; a magnesium content in the range of from 0 to 42 ppm, or from 0 to 25 ppm; and a sodium content in the range of from 0 to 30 ppm, or from 0 to 15 ppm.

In an alternative embodiment, the purified lignin obtained by the method according to the first aspect may have an aluminum content in the range of from 0.1 to 17 ppm, or from 0.1 to 13 ppm; a calcium content in the range of from 0.1 to 16 ppm, or from 0.1 to 10 ppm; a potassium content in the range of from 0.1 to 10 ppm, or from 0.1 to 5 ppm; a magnesium content in the range of from 0.1 to 42 ppm, or from 0.1 to 25 ppm; and a sodium content in the range of from 0.1 to 30 ppm, or from 0.1 to 15 ppm.

The lignin provided as a starting material in step a) of the method according to the first aspect preferably has a metal content in the range of from 500 ppm to 5000 ppm. This means that the reduction in total metal content by the inventive method may be at least 60%, preferably at least 70% and more preferably at least 80%.

Other inorganic impurities, such as silicon, may also be removed from lignin to the acidic aqueous solution during the immersion step. Thus, in one embodiment of the method according to the first aspect, silicon is also removed from lignin to the acidic aqueous solution in the immersion step; and the obtained purified lignin has a silicon content of less than 80 ppm, such as in the range of from 0 to 80 ppm, or from 0.1 to 80 ppm.

The purified lignin obtained by the method according to the first aspect may be subjected to further treatments, such as various heat treatments.

The purified lignin obtained by the method according to the first aspect is particularly suited for further conversion to carbon enriched materials intended for energy storage applications as well as for other applications where a lignin material having a total metal content of less than 200 ppm is of interest.

The lignin according to the second aspect of the present invention has a total metal content below or equal to 200 ppm. This lignin is obtained by the method according to the first aspect. Due to the low metal content of the lignin, it is suitable for further conversion to a carbon enriched material that can be used in energy-storage applications. The lignin according to the second aspect may be further defined as set out above with reference to the first aspect.

### EXAMPLES

In all examples, kraft lignin powder obtained from the LignoBoost process was used.

The content of inorganics, such as aluminium, calcium, iron, potassium, magnesium, manganese, sodium and silicon, in the lignin samples (i.e. lignin powder subjected to various treatments) was evaluated with ICP-OES (Inductively Coupled Plasma-Optical Emission Spectrometry). The lignin samples were oxidized with hydrogen peroxide and subsequently wet digested in a microwave oven with nitric acid. The contents of inorganics were quantified by ICP-OES. The total metal content was calculated by summarizing the contents of individual metals.

The content of inorganics in the lignin powder starting material prior to any treatment (sample 0) was also evaluated with ICP analysis, see table 1.

TABLE 1
Content of inorganics in kraft lignin powder,

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 0 | 936 | 19 | 20 | 17 | 60 | 50 | 12 | 748 | 103 |

“Metal” refers to total metal content.

### Example 1-Type Of Acid

Kraft lignin powder from the LignoBoost process (150 g) was added to heated water (1.5 1, 60° C. or 80° C.) during stirring. Thereafter 7.5 g (5 wt % based on the dry weight of lignin added to the water) of acid (oxalic acid, formic acid, phosphoric acid or sulfuric acid) was added and the mixture was stirred at a maintained temperature for a time period of 4 hours.

Subsequently the mixture was filtered, and lignin collected and dried in a vacuum oven at 60° C. overnight. The experimental details are summarized in table 2 and the results from ICP analysis are summarized in table 3. It can be noted that oxalic acid at 80° C. (1d) gives the highest lignin purity both in terms of lowest total metal content and lowest level of critical transition metals such as Fe and Mn.

TABLE 2
Experimental details for example 1

| Sample | | Amount | Temperature | Time |
|---|---|---|---|---|
| (number) | Acid | (wt %) | (° C.) | (hours) |
| 1a | oxalic acid | 5 | 60 | 4 |
| 1b | formic acid | 5 | 60 | 4 |
| 1c | phosphoric acid | 5 | 60 | 4 |
| 1d | oxalic acid | 5 | 80 | 4 |
| 1e | sulfuric acid | 5 | 80 | 4 |

TABLE 3
Content of inorganics in samples from example 1.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 1a | 103 | 13 | 11 | 12 | 2.7 | 41 | 9.2 | 10 | 70 |
| 1b | 132 | 16 | 17 | 15 | 3.7 | 41 | 9.8 | 21 | 73 |
| 1c | 273 | 17 | 13 | 14 | 13 | 41 | 9.6 | 158 | 71 |
| 1d | 90 | 12 | 16 | 8.8 | 3.4 | 24 | 4.8 | 14 | 54 |
| 1e | 105 | 13 | 8.8 | 12 | 4.0 | 29 | 6.5 | 23 | 48 |

“Metal” refers to total metal content.

### Example 2-Comparative Example

In a comparative example, kraft lignin powder from the LignoBoost process (150 g) was added to heated water (1.5 l) having a temperature of 60° C. (sample 2a) or 80° C. (sample 2b) during stirring. The mixture was stirred at a maintained temperature for a time period of 4 hours. No acid was added. Subsequently the mixture was filtered, and lignin collected and dried in a vacuum oven at 60° C. overnight. The results from ICP analysis are summarized in table 4.

TABLE 4
Content of inorganics in samples from example 2.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 2a | 274 | 20 | 13 | 17 | 15 | 42 | 11 | 143 | 74 |
| 2b | 315 | 18 | 7.3 | 15 | 18 | 21 | 4.9 | 220 | 51 |

“Metal” refers to total metal content.

### Example 3-Amount Of Acid Added

Kraft lignin powder from the LignoBoost process (150 g) was added to heated water (1.5 1, 60° C. or 80° C.) during stirring. Thereafter 1.5 g or 7.5 g (1 wt % or 5 wt % based on the dry weight of lignin added to the water respectively) of acid (oxalic acid or formic acid) was added and the mixture was stirred at a maintained temperature for a time period of 4 hours. Subsequently the mixture was filtered, and lignin collected and dried in a vacuum oven at 60° C. overnight. The experimental details are summarized in table 5 and the results from ICP analysis are summarized in table 6. It is evident that increasing the amount of acid to 5 wt % from 1 wt % has only a minor effect when washing is maintained for four hours at 60-80° C.

TABLE 5
Experimental details for example 3

| Sample | | Amount | Temperature | Time |
|---|---|---|---|---|
| (number) | Acid | (wt %) | (° C.) | (hours) |
| 3a | oxalic acid | 1 | 80 | 4 |
| 3b | oxalic acid | 5 | 80 | 4 |
| 3c | formic acid | 1 | 60 | 4 |
| 3d | formic acid | 5 | 60 | 4 |

TABLE 6
Content of inorganics in samples from example 3.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 3a | 78 | 10 | 6.6 | 11 | 2.5 | 22 | 4.7 | 14 | 47 |
| 3b | 90 | 12 | 16 | 8.8 | 3.4 | 24 | 4.8 | 14 | 54 |
| 3c | 143 | 17 | 17 | 15 | 6.2 | 41 | 10 | 25 | 77 |
| 3d | 132 | 16 | 17 | 15 | 3.7 | 41 | 9.8 | 21 | 65 |

“Metal” refers to total metal content.

### Example 4—Temperature of Acidic Aqueous Solution

Kraft lignin powder from the LignoBoost process (150 g) was added to water (1.5 l) during stirring. The water was heated to 20° C. (sample 4a), 60° C. (sample 4b), or 80° C. (sample 4c). Thereafter 7.5 g (5 wt % based on the dry weight of lignin added to the water) of oxalic acid was added and the mixture was stirred at a maintained temperature for a time period of 4 hours. Subsequently the mixture was filtered, and lignin collected and dried in a vacuum oven at 60° C. overnight. The results from ICP analysis are summarized in table 7. It is clear that increasing the temperature from 20° C. to 60° C. or 80° C. leads to a decrease of residual metal levels by 50% or more.

Increasing the temperature from 60° C. to 80° C. helps to further reduce the content of metals such as Fe, Mg and Mn.

TABLE 7
Content of inorganic in samples from example 4.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 4a | 208 | 17 | 13 | 17 | 11 | 41 | 9.4 | 86 | 72 |
| 4b | 103 | 13 | 11 | 12 | 2.7 | 41 | 9.2 | 10 | 70 |
| 4c | 90 | 12 | 16 | 8.8 | 3.4 | 24 | 4.8 | 14 | 54 |

“Metal” refers to total metal content.

### Example 5-Immersion Time

Kraft lignin powder from the LignoBoost process (150 g) was added to heated water (1.5 1, 60° C. or 80° C.) during stirring. Thereafter 7.5 g (5 wt % based on the dry weight of lignin added to the water) of oxalic acid or formic acid was added and the mixture was stirred at a maintained temperature for a time period of from 15 minutes to 4 hours. Subsequently the mixture was filtered, and lignin collected and dried in a vacuum oven at 60° C. overnight. For one sample (5d), the lignin was collected after filtration and subjected to a second immersion. All parameters were the same for both immersion steps, and thus the total immersion time was 8 hours. The experimental details are summarized in table 8 and the results from ICP analysis are summarized in table 9. It can be seen that washing for 1h is enough to reach a low total metal content of 86 ppm. Although it is also clear that the combination of higher temperature and longer washing time yields the highest purity lignin. Two repeated wash trials at 80° C., 4h could bring all individual metal levels, except magnesium, below 10 ppm and a total metal to 58 ppm.

TABLE 8
Experimental details for example 5

| Sample | | Amount | Temperature | Time |
|---|---|---|---|---|
| (number) | Acid | (wt %) | (° C.) | (hours) |
| 5a | oxalic acid | 5 | 80 | 0.25 |
| 5b | oxalic acid | 5 | 80 | 1 |
| 5c | oxalic acid | 5 | 80 | 4 |
| 5d | oxalic acid | 5 | 80 | 2 × 4 |
| 5e | oxalic acid | 5 | 60 | 1 |
| 5f | oxalic acid | 5 | 60 | 4 |
| 5g | formic acid | 5 | 80 | 0.25 |
| 5h | formic acid | 5 | 80 | 1 |

TABLE 9
Content of inorganics in samples from example 5.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 5a | 115 | 14 | 16 | 11 | 6.2 | 28 | 6.4 | 23 | 77 |
| 5b | 86 | 12 | 8.5 | 11 | 4.8 | 25 | 5.7 | 12 | 62 |
| 5c | 90 | 12 | 16 | 8.8 | 3.4 | 24 | 4.8 | 14 | 54 |
| 5d | 58 | 9.3 | 5.3 | 7.0 | 3.1 | 17 | 3.3 | 6.7 | 62 |
| 5e | 171 | 20 | 16 | 14 | 10 | 43 | 9.4 | 36 | 130 |
| 5f | 103 | 13 | 11 | 12 | 2.7 | 41 | 9.2 | 10 | 70 |
| 5g | 117 | 17 | 8.2 | 13 | 7.0 | 26 | 6.1 | 26 | 65 |
| 5h | 100 | 16 | 9.4 | 11 | 6.7 | 18 | 3.8 | 21 | 59 |

“Metal” refers to total metal content.

In view of the above detailed description of the present invention, other modifications and variations will become apparent to those skilled in the art. However, it should be apparent that such other modifications and variations may be effected without departing from the spirit and scope of the invention.

1. A method for purifying lignin, wherein the method comprises the following steps:
a) providing lignin in solid form;
b) providing an acidic aqueous solution having a pH below 6;
c) immersing the lignin in the acidic aqueous solution for at least 15 minutes, wherein the a temperature of the acidic aqueous solution during the immersion is in the a range of from 40°° C. to 100° C., to remove metals from the lignin to the acidic aqueous solution so as to obtain said a purified lignin; and,
d) separating the obtained purified lignin from the acidic aqueous solution to obtain a separated purified lignin; and
e) optionally, washing the separated purified lignin;
wherein the lignin remains in solid form during all steps of the method.

2. The method according to claim 1, wherein the lignin provided in step a) is kraft lignin.

3. The method according to claimb 1, wherein the lignin provided in step a) has a total metal content of at least 500 ppm.

4. The method according to claim 1, wherein the lignin provided in step a) has an aluminum content of at least 18 ppm; a calcium content of at least 18 ppm; an iron content of at least 16 ppm; a potassium content of at least 30 ppm; a magnesium content of at least 45 ppm; a manganese content of at least 11 ppm; and a sodium content of at least 400 ppm.

5. The method according to claim 1, wherein the lignin is provided as particlesin the wherein a particle size distribution of said particles is such that at least 80 wt-% of the particles have a diameter less than 0.2 mm.

6. The method according to claim 1, wherein a total amount of acid in the acidic aqueous solution is in the a range of from 0.1 to 6 wt % based on the a dry weight of lignin immersed in the acidic aqueous solution.

7. The method according to claim 1, wherein the acidic aqueous solution comprises at least one organic acid.

8. The method according to claim 7, wherein the at least one organic acid is selected from a group consisting of: formic acid and oxalic acid.

9. The method according to claim 1, wherein the separating of step d) is performed using filtration.

10. The method according to claim 1, wherein steps c) and-d), and optionally e), are each repeated at least one time.

11. The method according to claim 1, wherein the separated purified lignin is subjected to washing with an aqueous washing solution.

12. The method according to claim 1, further comprising: an additional step of drying the separated purified lignin.

13. The method according to claim 1, wherein the purified lignin has a total metal content of less than 200 ppm.

14. The method according to claim 1, wherein the obtained purified lignin has an iron content of less than 15 ppm.

15. The method according to claim 1, wherein the obtained purified lignin has a manganese content of less than 10 ppm.

16. The method according to claim 1, wherein the purified lignin has an aluminum content of less than 17 ppm; a calcium content of less than 16 ppm; a potassium content of less than 10 ppm; a magnesium content of less than 42 ppm; and a sodium content of less than 30 ppm.

17. Lignin having a total metal content of less than 200 ppm.

18. The lignin according to claim 17, wherein the lignin has an iron content of less than 15 ppm.

19. The lignin according to claim 17, wherein the lignin has a manganese content of less than 10 ppm.

20. The lignin according to claim 17, wherein the lignin has an aluminum content of less than 17 ppm; a calcium content of less than 16 ppm; a potassium content of less than 10 ppm; a magnesium content of less than 42 ppm; and a sodium content of less than 30 ppm.

21. The lignin according to claim 17, wherein the lignin is kraft lignin.
